(19) United States
(12) Patent Application Publication
(10) Pub. No.: US 2007/0261236 A1
(43) Pub. Date: Nov. 15, 2007

(54) Method of making electrical connector

(75) Inventor: Ted Ju, Anloku (TW)

Correspondence Address: BIRCH STEWART KOLASCH & BIRCH, PO BOX 747, FALLS CHURCH, VA, 22040-0747, US

(73) Assignee: Lotes Co., Ltd

(21) Appl. No.: 11/542,190

(22) Filed: Oct. 4, 2006

(30) Foreign Application Priority Data
May 15, 2006 (CN) 200610035465.6

(51) Int. Cl. H01R 43/16; C23C 26/00

(52) U.S. Cl. 29/874; 29/884; 427/96.1

(57) ABSTRACT

The invention is to provide a method of making an electrical connector. The method of making an electrical connector includes the following steps: (1) providing an insulator, which has a plurality of contact portions and a plurality of connecting portions, (2) coating a conducting layer on the insulator by a physical coating method, and (3) cutting the conducting layer between the contact portions and the connecting portions, such that the contact portions are formed as independent conducting areas. According to the method of making an electrical connector of the invention, the method is simple and does not use conducting terminals that have been compressed or bent several times. In this way, the quality is easily ensured, and the electrical connectors made by the method are capable of performing effective contacting with the electrical components.

### BACKGROUND OF THE INVENTION

1. Field of the Invention

This present invention relates to a method of making an electrical connector.

2. Description of the Prior Art

Currently, an electrical connector of the prior art generally includes an insulator and conducting terminals accommodated in the insulator. The insulator has terminal-accommodating cavities, and the conducting terminals are accommodated in the terminal-accommodating cavities, wherein each conducting terminal has a mounting portion and contact portions at the two ends; the electrical connection of the two electrical components is achieved by compressing and contacting the two electrical components. However, the conducting terminals are generally made of metal and processed, the shape of which is complicated, and the further processing of which is difficult; it is also easy to be permanently deformed after being compressed and bent several times, which causes the electrical connector to be unable to efficiently contact with the electrical components, thus affecting the capacity of the electrical connector.

Therefore, there is a need to invent a method of making an electrical connector that produces a new electrical connector to solve the defects mentioned above.

### SUMMARY OF THE INVENTION

The scope of the present invention provides a method of making an electrical connector. An electrical connector made by the method can perform efficient contacting with electrical components. Furthermore, the process of manufacturing is simplified.

To achieve the above scope, the method of making an electrical connector of the invention includes the following steps: (1) providing an insulator, which has a plurality of contact portions and a plurality of connecting portions, (2) coating a conducting layer on the insulator by a physical coating method, and (3) cutting the conducting layer between the contact portions and the connecting portions by laser, such that the contact portions are formed as independent conducting areas.

Comparing with the prior art, the method of making an electrical connector of the invention is simplified, conducting terminals that have been compressed or bent several times are not used, so the quality is easily ensured; furthermore, the electrical connectors made by the method are capable of performing more effective contacting with the electrical components.

The advantage and spirit of the invention may be further understood by the following description together with the appended drawings.

### BRIEF DESCRIPTION OF THE APPENDED DRAWINGS

FIG. 1 is a schematic diagram of the conducting layer of the electrical connector of the invention.

FIG. 2 is another view of the electrical connector shown in FIG. 1.

FIG. 3 is a partially enlarged view of FIG. 1.

FIG. 4 is a partially enlarged view of FIG. 2.

FIG. 5 is a schematic diagram of the electrical connector shown in FIG. 1 after being cut with laser.

FIG. 6 is another view of the electrical connector shown in FIG. 5.

FIG. 7 is a partially enlarged view of FIG. 5.

FIG. 8 is a partially enlarged view of FIG. 6.

FIG. 9 is a partial cross section of the electrical connector shown in FIG. 1.

FIG. 10 is a partially enlarged view of FIG. 9.

FIG. 11 is a schematic diagram of the electrical connector with another structure, made by the method of the invention, after being coated with a conducting layer.

FIG. 12 is a schematic diagram of the electrical connector shown in FIG. 11 after being cut with laser.

### DETAILED DESCRIPTION OF THE INVENTION

The following further describe the invention with the attached figures and the embodiments.

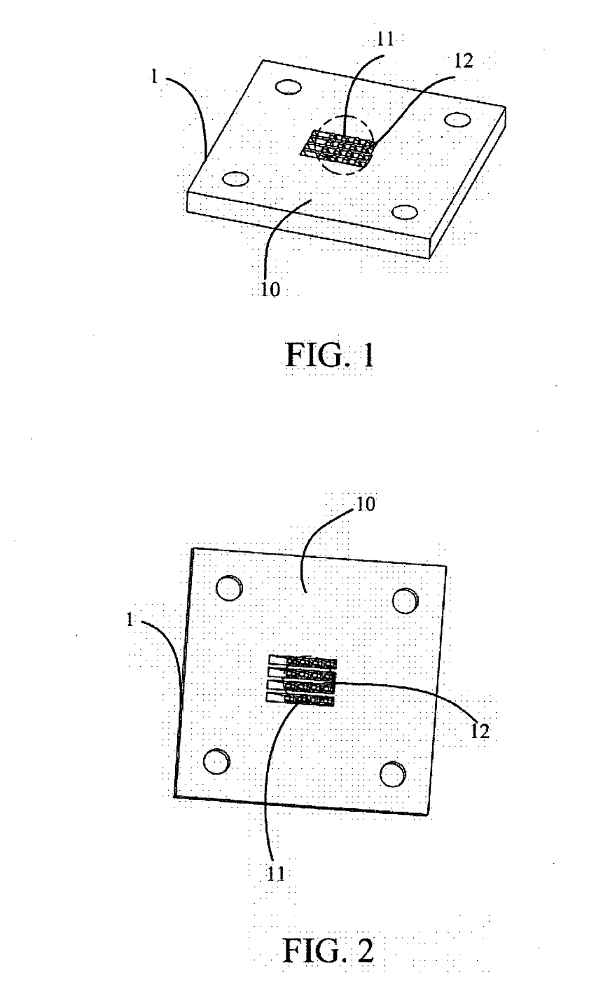

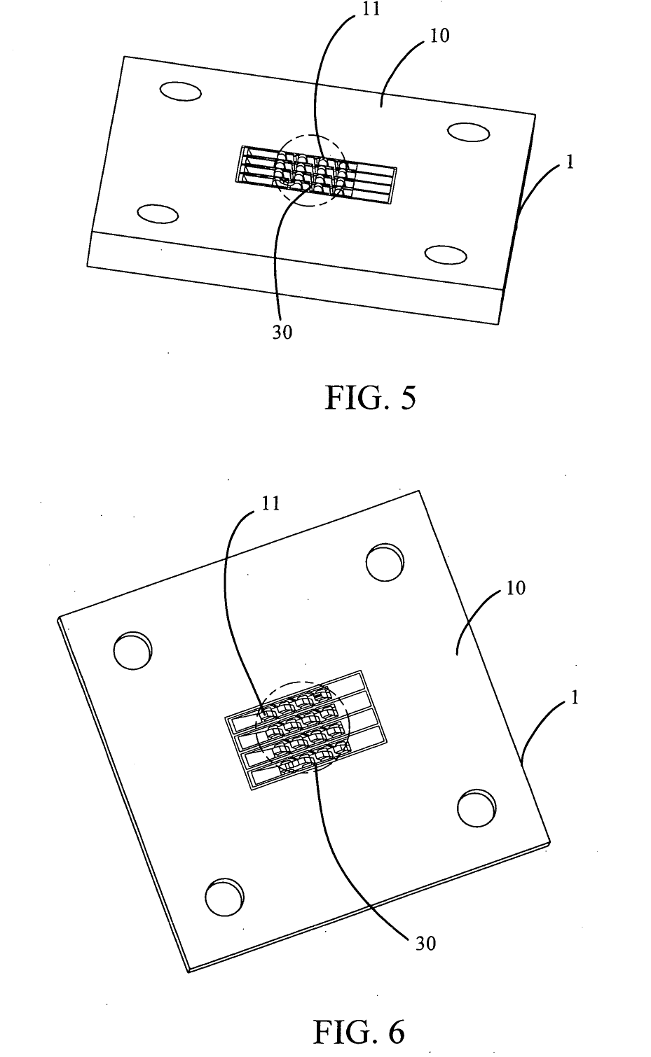

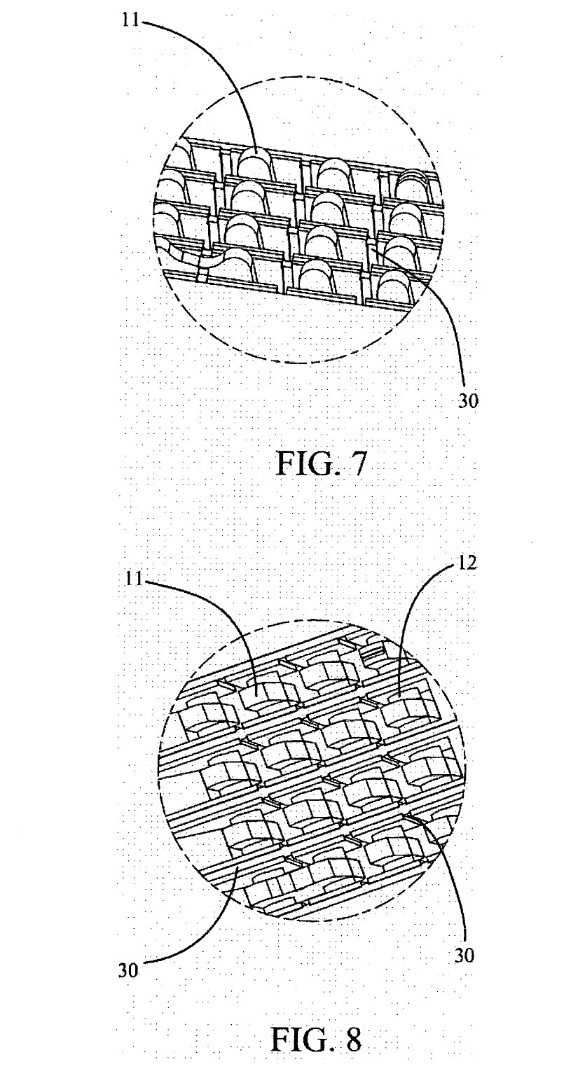

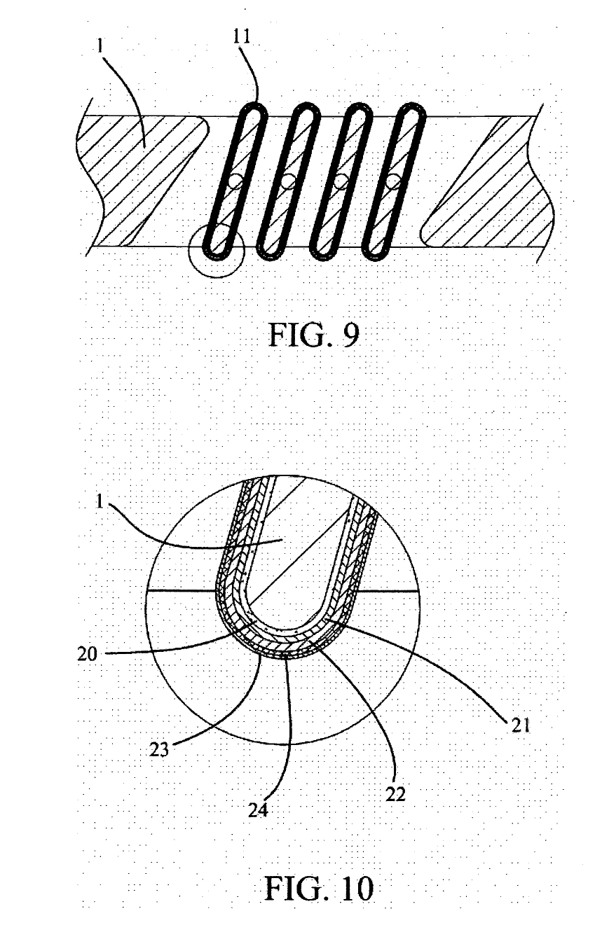

Referring to FIGS. 1 to 10, a method of making an electrical connector of the invention includes the following steps. Step (1) provides an insulator 1. The insulator 1 is a resilient rubber, including a main portion 10, a plurality of contact portions 11 protruding out of the surfaces of the main portion 10, and connecting portions 12 for connecting the main portions 10 and the contact portions 11 (only partial contact portions and connecting portions are shown in figures). The contact portion 11 is resilient and is capable of being compressed to connect with an electrical component (such as chip module or printed circuit board, which is not shown in figures). At the same time, the contact portions 11 are capable of swinging with respect to the main portion 10 of the insulator 1. Step (2) is for coating a conducting layer 21 (the conducting layer is a first conducting layer 21, and the first conducting layer 21 is copper) on the insulator 1 by a physical coating method. The physical coating method is vacuum sputtering. Furthermore, to increase the coherent force between the insulator 1 and the first conducting layer 21, a layer of material 20 can be coated on the surface of the insulator 1 before the first conducting layer 21 is coated on the insulator 1. After the first conducting layer 21 is coated completely, a second conducting layer 22 is plated on the first conducting layer 21 by plating. The second conducting layer 22 is also copper. The purpose of plating the second conducting layer 22 is to increase the thickness of the first conducting layer 21, so as to enhance the lifetime and the capacity of conducting of the electrical connector; an external conducting layer 23 with high conductivity and high inertia can also be coated on the second conducting layer 22. In the embodiment, the external conducting layer 23 is gold. Moreover, to enhance the wear resistance of the contact portions 11, a nickel layer 24 can be coated before the external conducting layer 23 is coated on the second conducting layer 22. Step (3) is for cutting the conducting layers (including the first, the second, and the external conducting layers 21, 22, 23) between the contact portions 11 and the connecting portions 12 by laser cutting, such that independent conducting areas are formed from the contact portions. There is a groove 30 between the contiguous conducting areas. Each independent conducting area is equivalent to an independent conducting terminal made by a customary technique. Thus, the electrical connector 100 is formed. As the electrical connector 100 connects with an electrical component (such as chip and printed circuit board, which are not shown in figures), the two ends of the contact portion 11 are deformed under compression; the connecting portion 12 connects the contact portion 11 and the main portion 10, and the contact portion 11 is capable of swinging through the connecting portion 12 with respect to the main portion 10. Therefore, when the contact portion 11 is deformed, most of the deformation is concentrated on the connecting portion 12, which can avoid cracking the metal layers of the contact portion 11 due to the larger force on the contact portion 11.

According to the method of making an electrical connector of the invention, in step (2), the process of coating the second conducting layer 22, the nickel layer 24, and the external conducting layer 23 on the first conducting layer 21 can be proceeded after step (3) is completed. This is advantageous for saving metal material while still obtaining the electrical connector in the above embodiment.

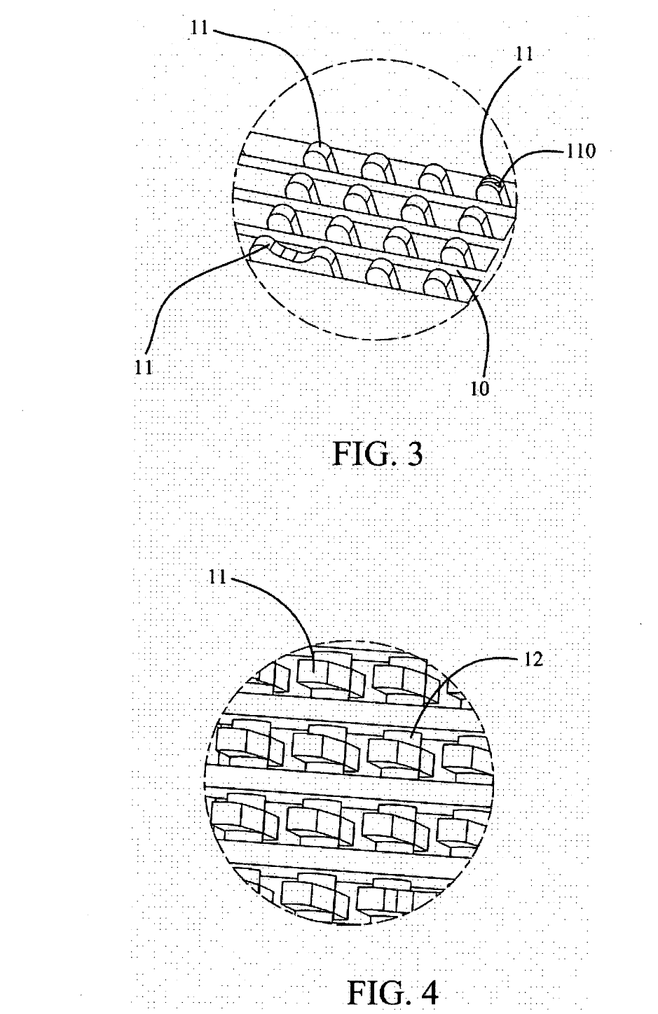

To make the contact portions 11 capable of connecting with different contact points, the contact portions 11 can be divided into several kinds. As shown in FIG. 3, one of the contact portions 11 is bigger than others. Also shown in FIG. 3, a dent 110 is formed on the contact portion 11 to form multi-contact points thereon.

The method of making an electrical connector of the invention is simple, and it does not to use conducting terminals that have been compressed or bent several times, so the quality is easily ensured, and the electrical connectors made by the method are capable of performing effective contacting with the electrical components.

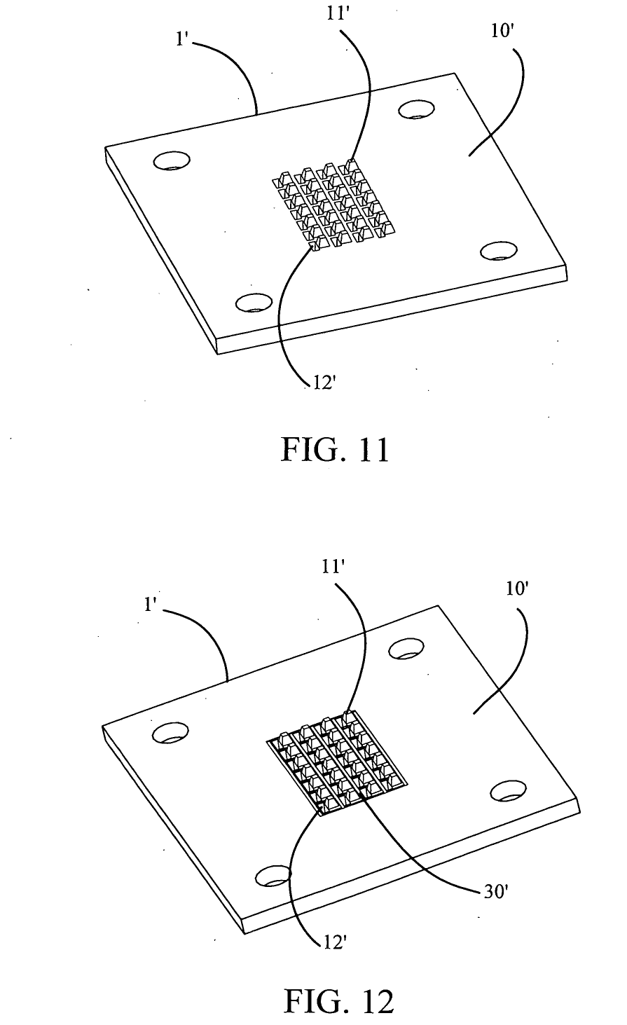

FIG. 11 and FIG. 12 are diagrams of the electrical connector 1′ with another structure made by the method of the invention. Contact portions 11′ of the electrical connector 1′ cannot swing with respect to a main portion 10′. An accommodating space 12′ accommodating the deformation of the contact portion 11′ is disposed between the contiguous contact portions 11′. In the electrical connector 1′ of this structure, grooves 30′ are cut out on the surfaces of the insulator 1′ in the laser cutting process, and then the conducting layer is cut into independent conducting areas.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A method of making an electrical connector, comprising the steps of:
(1) providing an insulator, comprising a plurality of contact portions and a plurality of connecting portions;
(2) coating a conducting layer on the insulator by a physical coating method; and
(3) cutting the conducting layer between the contact portions and the connecting portions such that the contact portions are formed as independent conducting areas.

2. The method of making an electrical connector of claim 1, further comprising the step of
coating a second conducting layer on the conducting layer after step (2) or step (3).

3. The method of making an electrical connector of claim 2, wherein the second conducting layer is copper.

4. The method of making an electrical connector of claim 1, further comprising the step of
coating an external conducting layer with high conductivity and high inertia on the conducting layer after step (2) or step (3).

5. The method of making an electrical connector of claim 4, wherein the external conducting layer is gold.

6. The method of making an electrical connector of claim 4, wherein a nickel layer is formed between the external conducting layer and the conducting layer.

7. The method of making an electrical connector of claim 1, wherein the conducting layer is copper.

8. The method of making an electrical connector of claim 1, wherein the physical coating method is vacuum sputtering.

9. The method of making an electrical connector of claim 1, wherein the insulator is a resilient rubber.

10. The method of making an electrical connector of claim 1, wherein the contact portions are resilient and are capable of resiliently contacting.

11. The method of making an electrical connector of claim 1, wherein the contact portions are capable of swinging with respect to the insulator.

12. The method of making an electrical connector of claim 1, wherein a medium is formed between the insulator and the conducting layer.
